(19) United States
(12) Patent Application Publication
(10) Pub. No.: US 2019/0037897 A1
(43) Pub. Date: Feb. 7, 2019

(54) AMORPHOUS COOLER DISPERSION COMPOSITION

(71) Applicant: International Flavors & Fragrances Inc., New York, NY (US)

(72) Inventors: Jung-A KIM, Edgewater, NJ (US); Adam TOTH, Aberdeen, NJ (US); Ronald GABBARD, Famingdale, NJ (US); Samantha RENNIE, South Amboy, NJ (US); Willy W. LEE, Bridgewater, NJ (US)

(73) Assignee: International Flavors & Fragrances Inc., New York, NY (US)

(21) Appl. No.: 16/087,721

(22) PCT Filed: Mar. 27, 2017
(86) PCT No.: PCT/US2017/024272

§ 371 Date: Sep. 24, 2018

Related U.S. Application Data
(60) Provisional application No. 62/313,397, filed on Mar. 25, 2016.

(51) Int. Cl. A23L 27/00; A23G 4/10; A23P 10/25; A23P 10/47; A23P 10/30

(52) U.S. Cl. CPC A23L 27/72; A23L 27/80; A23G 4/10; A23P 10/25; A23P 10/47; A23P 10/30; A23V 2300/16; A23V 2200/224; A23V 2200/15; A23V 2250/5114; A23V 2250/5118; A23V 2250/64; A23V 2002/00

(57) ABSTRACT

A composition containing one or more water-insoluble cooling agents, each having a water solubility of 2 mg/g or less, and being encapsulated in a water-soluble matrix including at least one water-soluble carbohydrate; and at least one emulsifier, and a method for producing the same are described.

### INTRODUCTION

This application claims the benefit of priority of U.S. Provisional Application No. 62/313,397, filed Mar. 25, 2016, the content of which is incorporated herein by reference in its entirety.

### BACKGROUND

Tastants such as cooling compounds are widely used in chewing gums and other consumer products to enhance taste and freshness. However, most of these compounds bind tightly to gum base and release only a very small portion during chewing, due to their high hydrophobicity. These tastants are typically solid or highly viscous, and poorly soluble in water, making them difficult to be encapsulated through common techniques employed in liquid flavor encapsulation, such as spray drying. Since tastants are typically high value compounds, developing effective microencapsulation systems that can improve their release is needed in the art.

In the pharmaceutical industry, hot-melt extrusion (HME) has been used in the encapsulation of poorly soluble solid crystalline drugs to improve their bioavailability (or solubility). The matrix polymers are typically amphiphilic polymers such as polyacrylates (EUDRAGIT), cellulose esters (HPMC-AS), or vinyl acetate polymers (KOLLIDON, SOLUPLUS). However, these materials are not approved for food applications.

The encapsulation of poorly soluble, solid tastants such as cooling agents in water-insoluble gum base ingredients such as polyvinyl acetate (PVAc) or its copolymers has been described. However, such materials are still fairly hydrophobic, and only partially improve the release of such poorly soluble coolers.

US 2007/0184163 discloses extruded compositions containing flavor oils that are capable of retaining their particle shape and integrity when exposed to high temperature and humidity, wherein the flavor is encapsulated in a matrix composed of distilled monoglycerides, mono- and diglycerides, sodium carboxymethylcellulose, hydroxypropylcellulose, methylcellulose, hydroxypropyl methylcellulose, ethylcellulose, silicon dioxide, calcium stearate, magnesium stearate.

US 2013/0243851 describes extrusion encapsulation of an active ingredient in a glassy matrix composed of surface active plant extract and a carbohydrate.

US 2014/0335224 discloses an encapsulated cooler system prepared by a wet granulation system. Cooling compounds are first dissolved in ethanol and mint oil or other hydrophobic media, then added to a carbohydrate mix (e.g., modified starch, gum arabic, maltodextrin, etc.) during granulation.

WO 2014/173922 describes a chewing gum containing a solid particulate cooling flavor including a vinyl polymer, a dipeptide sweetener and at least one N-substituted p-menthane-carboxamide; and a cooling mixture composed of one or more organic C₃-C₁₀ mono- and di-acids esterified with one or two menthol groups.

JP 61502656 describes the preparation of an extruded, solid essential oil flavor composition by blending sugar, starch hydrolysate, emulsifier and essential oil under pressure before extrusion.

CN 1925753 describes a method for producing a confection such as chewing gum, which incorporates a blend of menthyl glutarate and one or more of L-isopulegol and p-menthane-3,8-diol, wherein the blend of physiological cooling agents is made in a modified release structure.

EP 2520312 discloses a method of manufacturing an edible delivery system containing an active component encapsulated by extrusion in an encapsulating material such as PVAc, polyethylene, cross-linked polyvinylpyrrolidone, polymethylmethacrylate, polylactidacid, ethylcellulose, polyhydroxyalkanoates, polyvinyl acetate phthalate, polyethylene glycol esters, and methacrylic acid-co-methyl methacrylate.

U.S. Pat. No. 2,856,291 describes a method for producing solid flavoring compositions by mixing a volatile liquid flavoring agent with an edible carrier base including a mixture of sugars such as dextrose (glucose), corn syrup, and dextrin; extruding the mixture to form a continuous stream; cooling the stream to attain a plastic condition and cutting the same to produce rod-like elements in which the flavoring agent is protected from vaporization and deterioration.

U.S. Pat. No. 4,610,890 describes a solid flavor composition prepared by heating an aqueous mixture of sugar and starch hydrolysate together with an emulsifier and combining the resulting mixture with a flavor in a closed vessel under controlled pressure to form a homogeneous melt. The melt is then extruded into a relatively cool solvent, dried and combined with a selected anticaking agent to produce a stable, relatively non-hygroscopic particulate flavor composition of the invention.

U.S. Pat. No. 4,689,235 describes a method for preparing an encapsulating matrix composition by mixing maltodextrin, sugar, a liquid flavor and optionally an emulsifying agent in a tank, extruding the mixture and comminuting the extruded rods into desired lengths.

U.S. Pat. No. 4,707,367 teaches a process for preparing a stable, melt-based and extruded solid essential oil flavor composition which includes heating an aqueous mixture of a sugar and a starch hydrolysate together with an emulsifier, blending an essential oil flavor with the aqueous mixture to form a homogeneous melt, and extruding the homogeneous melt.

U.S. Pat. No. 5,476,675 teaches a method for preparing an edible fiber containing flavor product in granular form by mixing a powdered flavor material with maltodextrin and sugar, extruding the mixture in the forms of strands, and cutting the strands in an unsolidified state.

U.S. Pat. No. 5,709,895 relates to a process for producing flavor-containing sugar-free capsules via extrusion, wherein a flavor oil is encapsulated in a carbohydrate mixture containing modified starch(es) with hydrogenated saccharide(s).

U.S. Pat. No. 6,413,573 discloses a liquid flavor oil encapsulated in a glassy carbohydrate matrix composed of a blend of polydextrose and lactitol.

U.S. Pat. No. 6,902,751 describes a method for producing flavoring oils encapsulated in carbohydrates, which involves the extrusion of a carbohydrate mixture containing a flavoring followed by die-face pelletization during the solidification phase.

U.S. Pat. No. 6,932,982 describes a granular delivery system based on a matrix combining at least a carbohydrate material with from 1 to 7% of prehydrated agar agar, wherein the disclosed system is particularly stable in aqueous environments.

U.S. Pat. No. 8,334,007 describes a flavor or fragrance particulate composition prepared by extruding a candy-active molten mixture into cool organic solvent, wherein the extruded molten mass is broken up into particles and dried.

U.S. Pat. No. 8,641,945 describes vitreous aroma particles prepared by extrusion of an aromatized melt, followed by die-face pelletization, characterized in that the matrix of the particles contains from 20 to 80 weight % carbohydrate polymers having an average molecular weight greater than 1000, the aromatized melt is discharged from the extruder by way of an opening and is comminuted in the still unsolidified state.

### SUMMARY OF THE INVENTION

One aspect of the present invention provides a composition, in particular an amorphous composition, containing one or more solid, water-insoluble cooling agents, each having a water solubility of 2 mg/g or less (e.g., 1 mg/g or less, or 0.5 mg/g or less), and being encapsulated in a water-soluble matrix, wherein the water-soluble matrix is composed of at least one water-soluble carbohydrate and at least one emulsifier. More specifically, disclosed is a composition containing 5%-35% by weight of one or more water-insoluble cooling agents encapsulated in a water-soluble matrix, wherein said matrix is composed of 10%-50% by weight of one or more sugars or sugar alcohols; 10%-60% by weight at least one polymeric, water-soluble carbohydrate; and 0.1%-10% by weight of one or more emulsifiers. In some embodiments, the composition further includes a cooling enhancer. In other embodiments, the composition further includes 0-10% by weight of one or more liquid-absorbing materials. In further embodiments, the at least one water-soluble carbohydrate includes a modified starch, a dextrin, a sugar, a sugar alcohol (e.g., sorbitol, xylitol, isomalt or erythritol), or a combination thereof. In yet further embodiments, the one or more water-insoluble cooling agents are in the form of a solid crystalline powder or viscous liquid at ambient temperature.

Another aspect of this invention provides a method for encapsulating a water-insoluble cooling agent in a water-soluble carbohydrate matrix. The method involves the steps of (a) blending one or more water-insoluble cooling agents, each in the form of a solid or viscous liquid and having a water solubility of 2 mg/g or less; at least one water-soluble carbohydrate; and at least one emulsifier to produce a powder mixture; (b) melting the powder mixture in an extruder; (c) extruding the melted powder mixture through a die; and (d) cooling the extruded mixture to produce a glassy solid. More specifically, the method involves the steps of (a) blending, by weight, 5%-35% of one or more water-insoluble cooling agents with a water-soluble matrix composed of (i) 10%-50% of one or more sugars or sugar alcohols; (ii) 10%-60% of at least one water-soluble carbohydrate polymer; (iii) 0.1%40% of one or more emulsifiers; and (iv) 0-10% of one or more liquid-absorbing materials to produce a powder mixture; (b) melting the powder mixture in an extruder; (c) extruding the melted powder mixture through a die; and (d) cooling the extruded powder mixture to produce a glassy solid. In certain embodiments, the method further includes the step of (e) grinding the composition of claim 8 to a granule or powdered form.

### BRIEF DESCRIPTION OF THE DRAWINGS

FIG. 1 shows that chewing gum with an encapsulated cooler mixture containing 450 ppm Cooler Mixture 1 (Formulation 1) outperforms both the unencapsulated Cooler Mixture 1 (Formulation 2) and 1000 ppm WS-5 alone (Formulation 6). From 30 to 500 seconds and overall (across the whole curve), Formulation 1 had significantly higher cooling intensity compared to the other two samples at p=0.05. N=12.

FIG. 2 shows that 500 ppm encapsulated WS-5 (Formulation 4) outperformed 2000 ppm of neat WS-5 (Formulation 5). There was a significant different between the two samples at all the evaluation times at p=0.05. N=8.

FIG. 3 shows that 200 ppm unencapsulated WS-5 (Formulation 7) and Cooler Mixture C52 containing the same amount of WS-5 (Formulation 8) performed similarly. There was no significant different between the two samples at any of the evaluation times or overall at p=0.05. N=10.

FIG. 4 shows the cooling time intensity of chewing gums containing 2000 ppm WS-5 (formulation 5) or 2000 ppm WS-5 in combination with 2000 ppm Cooling Agent WS SD malto. There was no significant difference between the two samples from 2.5 minutes to the end at p=0.05.

FIG. 5 shows that an extruded composition of the invention is amorphous as determined by Differential Scanning calorimetery (DSC).

FIG. 6 shows cooling time intensity data for tablets containing neat WS-5 and encapsulated WS-5. N=12.

FIG. 7 provides DSC analysis of the loading capacity of WS-5.

FIG. 8 shows cooling time intensity of gum containing extruded compositions containing amorphous WS-5 and WS-5 in partially crystalline form.

FIG. 9 shows a comparison of an extruded composition containing a sugar-free (SF) matrix and a high-melt (HM) matrix as determined by DSC.

FIG. 10 provides DSC data showing that both WS-3 and WS-23 extruded compositions are amorphous.

### DETAILED DESCRIPTION OF THE INVENTION

It has now been found that the encapsulation of a water-insoluble cooling agent in a water-soluble carbohydrate matrix, enhances the cooling intensity of cooling agents, either alone or in combination with cooling enhancers. Accordingly, one aspect of the present invention provides a HME composition containing a water-insoluble cooling agent encapsulated in a water-soluble carbohydrate matrix and a method for producing the same.

For the purposes of this invention, a “cooling agent” or “coolant” refers to a compound that imparts a cooling sensation or enhances cooling sensation of another compound. In some embodiments, the cooling agent also imparts a flavor, e.g., menthol. In other embodiments, the cooling agent imparts a cooling sensation without the association of a specific flavor. “Cooling sensation” refers to a stimulus transmitted by the nerve endings present in the oral cavity and nose to the central nervous system that convey said sensation, which is not necessarily connected with a reduction in temperature. Cooling agents belong to different classes of compounds and preferentially act in particular areas (e.g., the palate, tongue and throat). Cooling agents of use in this invention include, but are not limited to the compounds listed in Table 1.

TABLE 1

| FEMA No. | Cooling Agent |
|---|---|
| 3804 | WS-23 (2-Isopropyl-N,2,3-trimethylbutyramide) |
| 3455 | WS-3 (N-Ethyl-p-menthane-3-carboxamide) |
| 4309 | WS-5 [Ethyl 3-(p-menthane-3-carboxamido)acetate] |
| 4681 | WS-12 (1R,2S,5R)-N-(4-Methoxyphenyl)-p-menthanecarboxamide |
| 4557 | WS-27 (N-Ethyl-2,2-diisopropylbutanamide) |
| 4693 | N-Cyclopropyl-5-methyl-2-isopropylcyclohexanecarboxamide |
| 4603 | WS-116 (N-(1,1-Dimethyl-2-hydroxyethyl)-2,2-diethylbutanamide) |
| 4154 | COOLACT ((−)-Menthoxyethanol) |
| 4496 | N-(4-cyanomethylphenyl)-p-menthanecarboxamide |
| 4549 | N-(2-(Pyridin-2-yl)ethyl)-3-p-menthanecarboxamide |
| 4602 | N-(2-Hydroxyethyl)-2-isopropyl-2,3-dimethylbutanamide |
| 4684 | N-(4-(carbamoylmethyl)phenyl)-menthylcarboxamide |
| 4718 | 2-[(2-p-Menthoxy)ethoxy] ethanol |
| 4680 | 2,6-Diethyl-5-isopropyl-2-methyltetrahydropyran |
| 4809 | 2-(p-tolyloxy)-N-(1H-pyrazol-5-yl)-N-((thiophen-2-yl)methyl)acetamide |
| 2962 | COOLACT P (isopulegol) |
| 3748 | FRESCOLAT ML (Menthyl lactate) |
| 3805 | FRESCOLAT MGC (Menthyl ethylene glycol carbonate) |
| 3807 | FRESCOLAT MGA (Menthone 1,2-glycerol ketal) |
| 3808 | FRESCOLAT MGA (racemic) (DL-Menthone 1,2-glycerol ketal) |
| 3810 | Menthyl succinate |
| 3806 | FRESCOLAT MPC (Menthyl 1&2 propylene glycol carbonates) |
| 3992 | COOLER 2 (Menthyl glutarate) |
| 4053 | COOLACT 38D (p-menthane-3,8-diol) |
| 4155 | QUESTICE (Menthyl pyrrolidone carboxylate) |
| 4230 | N,N-Dimethyl succinamide |
| 4285 | FRESHONE (Menthone-(S)-lactic acid ketal) |
| 4308 | Menthyl(S)-3-hydroxybutyrate |
| 4327 | ULTRACOOL 7 (Menthyl acetoacetate) |
| 4496 | EVERCOOL 180 ((1R,2S,5R)-N-(4- |
| | cyanomethyl)phenyl)menthylcarboxamide |
| 4497 | Cubebol |
| 4549 | EVERCOOL 190 ((1R,2S,5R)-N-(2-(pyridine-2- |
| | yl)ethyl)menthylcarboxamide |
| 4602 | N-(2-hydroxyethyl)-2,3-dimethyl-2-isopropylbutanamide |
| 4604 | Di-(−)-menthyl glutarate |
| 4684 | (1R,2S,5R)-N-(4-(carbamoylmethyl)phenyl)-menthylcarboxamide |
| 4718 | 2-[2-(p-menthan-3-yloxy)ethoxy]ethanol |
| 4742 | (1R,2R,4R)-1-(2-Hydroxy-4-methylcyclohexyl)ethanone |
| 4809 | 2-(p-tolyloxy)-N-(1H-pyrazol-5-yl)-N-((thiophen-2-yl)methyl)acetamide |

In some embodiments, the cooling agent is not a flavor ingredient. In particular embodiments, the cooling agent is not menthol. In other embodiments, the cooling agent has a relative cooling strength that is greater than or equal to menthol. For example, compared to menthol (as 100), WS-12, WS-3, and WS-5 respectively have relative cooling strengths of 150, 150, and 400.

In accordance with this invention, the cooling agent(s) is insoluble in water. The term “water-insoluble” means that the cooling agent does not readily dissolve in water, e.g., at ambient temperature. More specifically, the solubility of cooling agents is 2 mg/g or less, 1 mg/g or less, or 0.5 mg/g or less. In certain embodiments, the cooling agents are used in the form of viscous liquid or more preferably a crystalline solid prior to extrusion.

The composition of this invention can contain one, two, three, four, five or more cooling agents. In one embodiment, the composition contains at least one cooling agent. In another embodiment, the composition contains two cooling agents. In a further embodiment, the composition contains three cooling agents. The total cooling agent component of the encapsulated cooler composition represents about 5% to 35% by weight of the composition, or more desirably about 5% to 25% by weight of the composition, or more preferably, about 5% to 20% by weight of the composition.

As indicated, the water-insoluble cooling agent is encapsulated within a water-soluble matrix composed of at least one water-soluble carbohydrate and at least one emulsifier. “Water-soluble” refers to ability of the carbohydrate component and matrix of the present composition to be dissolved in water. Water-soluble carbohydrates include monomeric or dimeric sugars, sugar alcohols, or carbohydrate polymers such as dextrins, natural or modified starch, pectins, xanthanes, Gum Arabic, alginates, or cellulose derivatives such as carboxymethyl cellulose, methyl cellulose or hydroxyethylcellulose.

The composition of this invention can contain one, two, three, four, five or more water-soluble carbohydrates. In one embodiment, the composition contains at least one water-soluble carbohydrate. In another embodiment, the composition contains two water-soluble carbohydrates. In a further embodiment, the composition contains three water-soluble carbohydrates. In another embodiment, the composition contains four water-soluble carbohydrates. In certain embodiments, the composition contains at least one sugar or sugar alcohol and at least one carbohydrate polymer. More preferably, the composition contains two sugar alcohols and two carbohydrate polymers. The total water-soluble carbohydrate component of the encapsulated cooler composition represents about 20% to 90% by weight of the composition, or more desirably about 50% to 85% by weight of the composition, or more preferably, about 70% to 80% by weight of the composition.

Monomeric and dimeric sugars are known in the art and include, but are not limited to sucrose (i.e., cane sugar), glucose, fructose, tagatose, lactose, and trehalose. As used herein, the term “sugar alcohol” means a food-grade alcohol derived from a sugar molecule. Sugar alcohols useful in this invention include, for example, mannitol, sorbitol, lactitol, isomalt, erythritol, xylitol, maltitol, hydrogenated isomaltulose, and combinations thereof. The composition of this invention can contain one, two, three, four, five or more sugars, sugar alcohols or combinations thereof. In one embodiment, the composition contains at least one sugar or sugar alcohol. In another embodiment, the composition contains two sugar alcohols. In a further embodiment, the composition contains a sugar and a sugar alcohol. When included in the matrix of the present composition, the total amount of sugar and/or sugar alcohol component represents about 10% to 50% by weight of the composition, or more preferably about 25% to 30% by weight of the composition.

Modified starches include any of several water-soluble polymers derived from a starch (e.g., corn starch, potato starch, tapioca starch, waxy maize starch, high-amylose corn starch, potato starch, tapioca starch, rice starch, wheat starch) such as by acetylation, halogenation, hydrolysis (e.g., such as with an acid), or enzymatic action. Generally, any type of water-soluble modified starch, including but not limited to oxidized, ethoxyolated, cationic, lypophilic and pearl starch, may be used. Maltodextrins are a preferred class of modified starches obtained by hydrolysis. Commercially available maltodextrins that may be used in this invention include MALTRIN M100, MALTRIN M180, MALTRIN QD M550, and MALTRIN QD M600 (Grain Processing Corporation). Another commercially available modified starch that may be used is PURE-COTE B792 modified corn starch, also available from Grain Processing Corporation.

Hydroxypropylcellulose is a cellulose ether with hydroxypropyl substitution. Hydroxypropyl cellulose is also a nonionic, water-soluble carbohydrate polymer. Examples of commercially available hydroxypropyl cellulose materials that can be used include KLUCEL LF, KLUCEL JF, KLUCEL EF, KLUCEL EXF, KLUCEL EX, KLUCEL EXF, KLUCEL JX and KLUCEL JXF (Ashland Aqualon Functional Ingredients).

The composition of this invention can contain one, two, three, four, five or more different carbohydrate polymers. In one embodiment, the composition contains at least one carbohydrate polymer. In another embodiment, the composition contains two carbohydrate polymers. The total amount of carbohydrate polymer component of the encapsulated cooler composition of the invention represents about 10% to 60% by weight of the composition, or more preferably about 20% to 55% by weight of the composition.

The emulsifier used in the present composition is a natural and/or synthetic food-grade emulsifier. For example, the emulsifier can include lecithin, fatty acids (C₁₀-C₁₈), mono and diacyl glycerides, ox bile extract, polyglycerol esters, polyoxyethylene sorbitan esters, sorbitan monopalmitate, sorbitan tristerate, or combinations thereof. Preferably, the amount of the emulsifier component of the encapsulated cooler composition represents about 0.1% to 10% by weight or more preferably 1 to 5% by weight of the composition.

Ideally, the encapsulated cooler composition contains 5%-35% by weight of one or more water-insoluble cooling agents; 10%-50% by weight of one or more sugars or sugar alcohols; 10%-60% by weight at least one polymeric, water-soluble carbohydrate; 0.1%-10% by weight of one or more emulsifiers; and 0-10% of one or more liquid-absorbing materials. More specifically, the encapsulated cooler composition contains between two and three water-insoluble cooling agents, which collectively represent 5%-35% by weight of the composition; two sugar alcohols, which collectively represent 10%-50% by weight of the composition; two water-soluble carbohydrate polymers, which collectively represent 10%-60% by weight of the composition; 0.1%-10% by weight of an emulsifier; and 0-10% of one or more liquid-absorbing materials.

As indicated, the composition can include a liquid-absorbing powder material as part of the carbohydrate matrix. A “liquid-absorbing powder material” refers to a material capable of absorbing any liquid materials in the formulation; aiding in powder blending and powder flow; and/or minimizing the reduction of Tg for the encapsulated material. Exemplary liquid-absorbing powder materials include, but are not limited to silica, calcium phosphate, di-calcium phosphate, talc and kaolin. Preferably, the amount of the liquid-absorbing powder material of the encapsulated cooler composition represents about 0% to 10% by weight or more preferably 1 to 5% by weight of the composition.

A composition of the invention can be included in a number of consumer products including, but not limited to chewing gum, candies, cookies, baked goods, toothpaste, and personal hygiene products. When included in a consumer product, e.g., chewing gum, the encapsulated cooler composition of the present invention imparts a faster and stronger cooling sensation when administered to a consumer, even after 10 minutes of, e.g., chewing, as a result of improved cooler release. In particular, it imparts a cooling sensation even after or at 20, 30, 40 or 50 minutes of chewing.

In some embodiments, the composition further includes a cooling enhancer. A “cooling enhancer” or “cooling sensate enhancer” refers to a compound that enhances the cooling taste impression of a cooling agent. Examples of cooling enhancers include, but are not limited to, eriodictyol, homoeriodictyol, hespertin and menthoxypropanediol.

In addition to a cooling enhancer and liquid-absorbing powder material, the composition can contain additional flavors, colorants, carriers, emulsification aids, and the like. Flavors include essential oils, natural and artificial flavoring substances, flavors derived from heat treatment, smoked flavoring substances, solvents, and mixtures thereof.

Another aspect of this invention provides a method for encapsulating a water-insoluble cooling agent in a water-soluble carbohydrate matrix. The method involves the steps of blending one or more water-insoluble cooling agents, at least one water-soluble carbohydrate, and at least one emulsifier, each of which is described herein; melting the resulting powder mixture in an extruder; extruding the melted powder mixture through a die; and cooling the extruded mixture to produce a glassy solid. In some embodiments, the method further includes the step of grinding the glassy solid to a granule or powdered form.

More specifically, the method of the invention includes the steps of blending, by weight, 5%-35% of one or more water-insoluble cooling agents with a water-soluble matrix, wherein said matrix is composed of 10%-50% of one or more sugars or sugar alcohols, 10%-60% of at least one water-soluble carbohydrate polymer, 0.1%40% of one or more emulsifiers, and 0-10% of one or more liquid-absorbing materials to produce a powder mixture; melting the powder mixture in an extruder; extruding the melted powder mixture through a die; and cooling the extruded powder mixture to produce a glassy solid. In some embodiments, the method further includes the step of grinding the glassy solid to a granule or powdered form.

In accordance with known extrusion techniques, the carbohydrate matrix material(s), cooling agent(s), emulsifier(s) are heated to a molten state and extruded through a die to form strands of molten material, which is cooled to form a glass that protects the active ingredient(s) encapsulated in the carbohydrate matrix. The melted extrusion can be formed using any current extruder typically used according to prior known “wet extrusion” or “dry blend” (also called “flash-flow”) techniques. In some embodiments, the ingredients are heated at a temperature in the range of 30° C. to 200° C. to achieve a molten state. In certain embodiments, the ingredients are exposed to a maximum temperature of 200° C., 190° C., 180° C., 170° C., 160° C., 150° C., 140° C., 130° C., 120° C., 110° C., or 100° C. to achieve a molten state. In some embodiments, the multiple heating zones (e.g., 4, 5, 6, 7, 8, 9, 10 or more), at temperatures in the range of 30° C. to 200° C., are used in the extrusion method. Likewise, the extruded product can be formed into granules by any suitable means. For instance, it can be chopped while it is still in a plastic state (melt granulation or wet granulation techniques), or it can be cooled and subsequently ground or pulverized. If desired, the die orifice itself can be equipped with a cutter-knife or any other cutting device. Alternatively, the cutting device can be provided separately downstream from the die orifice. If desired, an anticaking agent can be added to the extruded product to prevent the granules from sticking to one another. In certain embodiments, the extruded composition has an amorphous structure, e.g., as determined by DSC.

The invention is described in greater detail by the following non-limiting examples.

### Example 1: Encapsulation Through HME

Compositions containing combinations of water-insoluble cooling agents and cooling enhancers were encapsulated in a water-soluble carbohydrate matrix through HME (Table 2).

TABLE 2

| | Amount (kg) | | |
|---|---|---|---|
| Ingredient | Composition 1 | Composition 2 | Composition 3 |
| Dextrin | 2.494 | 2.398 | 2.398 |
| Isomalt | 1.754 | 1.714 | 1.714 |
| Modified Starch | 1.600 | 1.600 | 1.600 |
| Sorbitol | 0.400 | 0.400 | 0.400 |
| WS-5 | 0.528 | 0.264 | 0.264 |
| Cooling Agent WS | 0.264 | 0.264 | 0 |
| Cooler 2 Extra | 0.400 | 0.800 | 0 |
| Silica | 0.400 | 0.400 | 0.400 |
| Sunflower Lecithin | 0.160 | 0.160 | 0.160 |
| Total | 8.000 | 8.000 | 6.936 |

Formulation.

In a Hobart mixer, dextrin, isomalt, modified starch, sorbitol, crystalline WS-5, and silica were mixed at low speed for five minutes. When included, Cooling Agent WS was subsequently added and the mixture was blended for 10 minutes. Similarly, when included, Cooler 2 Extra was mixed with sunflower lecithin in a separate beaker with an overhead mixer for 2-3 minutes.

Extrusion.

The tests were run on a Coperion ZSK-25 twin-screw extruder. The temperature settings were as follows: Zones 1 and 2 were 40° C., Zones 3 to 8 were 110° C. to 170° C., and the die block temperature was 110° C. The powder mix prepared above was fed into Zone 1/2 at a rate of 6.35 kg/hour. The material was extruded through a die block with a hole of 1 mm in diameter, and air-cooled on a belt.

Post Extrusion.

After air cooling, the extrudate was passed through a cone mill twice, with a 0.05″ screen and running at 1750 RPM. Then 2% silica (AEROSIL) was mixed in with the same Hobart mixer. Finally, the mixture was sieved through 18 mesh and 60 mesh screens, and the middle portion was retained as the final product. The levels of active ingredients in the final product are provided in Table 3.

TABLE 3

| | Weight Percent of Final Product | | |
|---|---|---|---|
| Ingredient | Composition 1 | Composition 2 | Composition 3 |
| WS-5 | 6.6 | 5.0 | 10.0 |
| Cooling Agent WS | 3.3 | 3.3 | 0 |
| Cooler 2 Extra | 5.0 | 10.0 | 0 |

### Example 2: Chewing Gum Preparations

Chewing gums were prepared, which included Compositions 1-3 (Formulations 1, 3 and 4) or unencapsulated coolers (Formulations 2 and 5-9) (Table 4).

TABLE 4

| Formulation | Cooler |
|---|---|
| 1 | 0.3% Composition 1 (450 ppm Cooler Mixture 1 including |
| | Cooling Agent WS, Cooler 2, and WS-5) |
| 2 (control 1) | 450 ppm Cooler Mixture 1 |
| 3 | 0.3% Composition 2 (500 ppm Cooler Mixture 2 including |
| | Cooling Agent WS, Cooler 2, and WS-5) |
| 4 | 0.5% Composition 3 (500 ppm WS-5) |
| 5 (control 2) | 0.2% pure WS-5 (2000 ppm WS-5) |
| 6 (control 3) | 0.1% pure WS-5 (1000 ppm WS-5) |
| 7 (control 4) | 0.02% pure WS-5 (200 ppm WS-5) |
| 8 | 0.045% cooler mixture C52 (450 ppm Cooler Mixture C52 |
| | including Cooling Agent WS, Cooler 2, and WS-5) |
| 9 | 2000 ppm WS-5 and 2000 ppm Cooling Agent WS SD |
| | Malto |

A blank chewing gum with a Cafosa Hades gum base, sorbitol as the bulk sweetener, aspartame and acesulfame K as the high intensity sweeteners was made in a Sigma Blade mixer. Then 1.4% mint oil and the indicated amounts of cooling agents/cooling enchancers were added and mixed for 3 minutes.

### Example 3: Sensory Tests

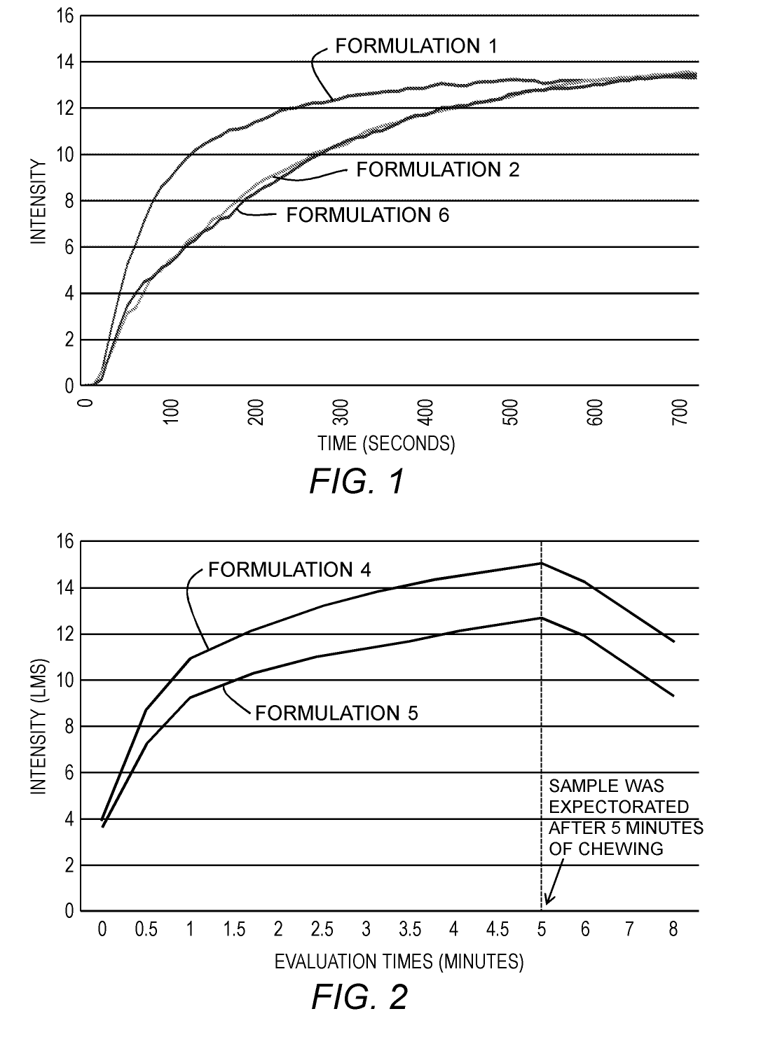

A panel of 12 trained sensory evaluators chewed Formulations 1, 2 and 6 for 12 minutes. Cooling intensity was recorded continuously with an electronic device. The test was blinded, randomized, and balanced. FIG. 1 shows that the encapsulated cooler mixture outperformed both unencapsulated cooler mixture and higher level WS-5 alone.

A panel of eight trained sensory evaluators chewed Formulations 4 and 5 for 5 minutes. Cooling intensity was recorded continuously with an electronic device. The test was blinded, randomized, and balanced. FIG. 2 shows that 500 ppm encapsulated WS-5 outperformed 2000 ppm of neat WS-5.

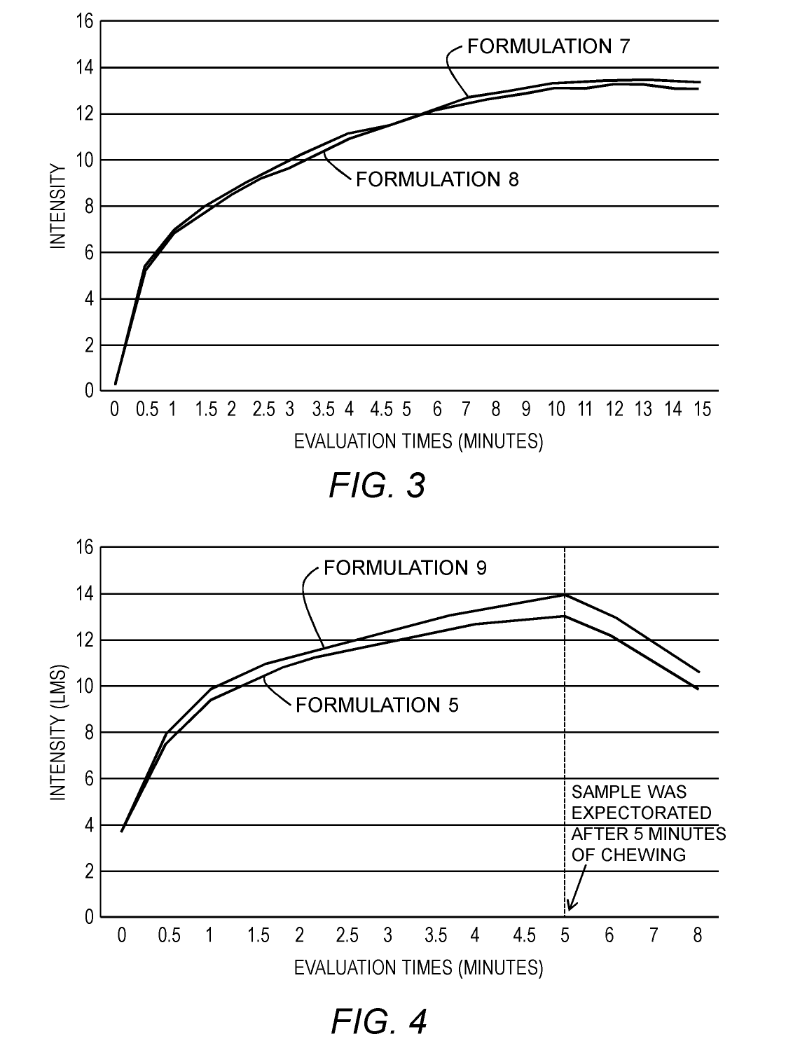

A panel of 10 trained sensory evaluators chewed Examples 7 and 8 for 15 minutes. Cooling intensity was recorded continuously with an electronic device. The test was blinded, randomized, and balanced. FIG. 3 shows that 200 ppm unencapsulated WS-5 and the cooler mixture containing the same amount of WS-5 performed similarly, which is an indication that the observed performance enhancement in FIG. 1 was likely due to the extrusion matrix, not the cooler mixture.

A panel of 9 trained sensory evaluators chewed Examples 5 and 9 for 15 minutes. Cooling intensity was recorded continuously with an electronic device. The test was blinded, randomized, and balanced. FIG. 4 shows that there was no significant difference between the two samples from 2.5 minutes to the end.

### Example 4: Combinations of Cooling Agents/Cooling Enhancers

Additional compositions containing combinations of water-insoluble cooling agents and cooling enhancers are listed in (Table 5).

TABLE 5

Composition (weight %)

| Cooling Agent/Enhancer | 4 | 5 | 6 | 7 |
|---|---|---|---|---|
| WS-5 | 4.1 | | | |
| Cooler 2 Extra | 5.0 | 10.0 | 5.0 | 5.0 |
| Cooling Agent WS | 3.3 | 3.3 | 3.3 | 3.3 |
| WS-12 | 2.5 | | | |
| WS-3 | | | 6.6 | |
| WS-23 | | | | 6.6 |
| Total Load | 14.9 | 13.3 | 14.9 | 14.9 |

### Example 5: Preparation of Amorphous Dispersions

Formulation.

In a Hobart mixer, 1.396 kg dextrin, 1.012 kg isomalt, 0.832 kg modified starch, 0.200 kg sorbitol, 0.400 kg WS-5, and 0.080 kg fumed silica were mixed at low speed for five minutes. Subsequently, 0.080 kg sunflower lecithin was slowly added to the above mixture and the resulting mixture was blended for 10 minutes.

Extrusion/Encapsulation.

The powder formulation prepared was fed into a Coperion ZSK-25 twin-screw extruder at a controlled rate. The highest zone temperature was set at 170° C. The material was extruded through a die block with a hole of 1 mm in diameter, and air-cooled on a belt.

Differential Scanning Calorimetery (DSC) Analysis:

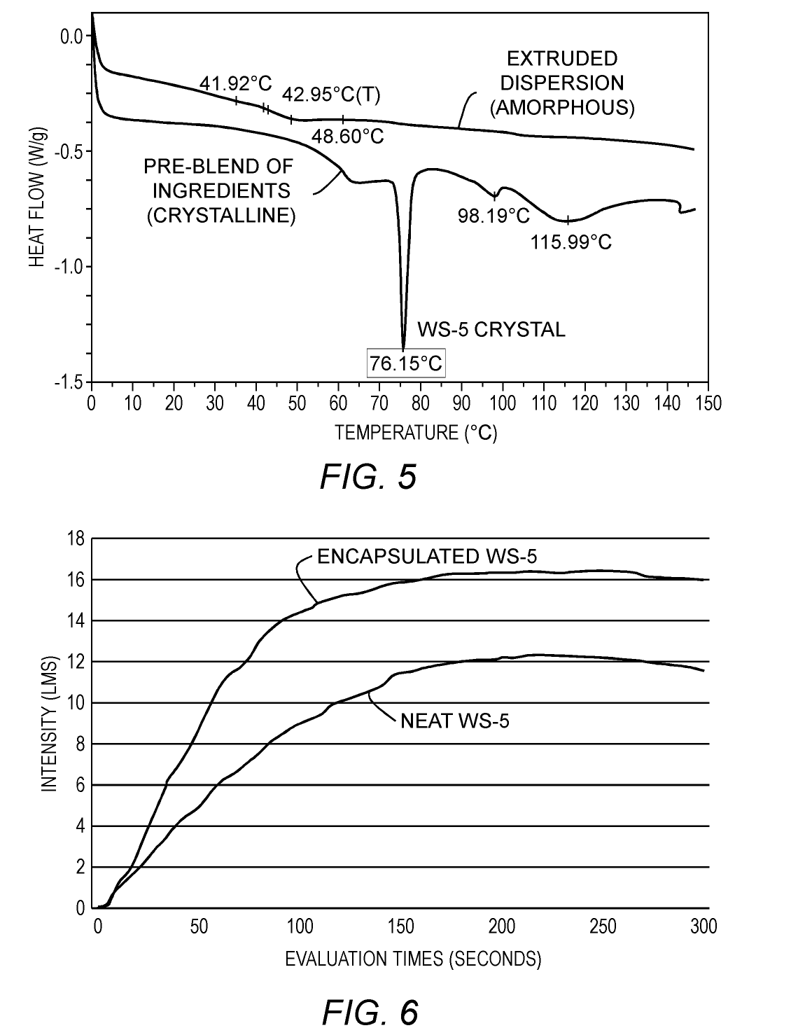

The powder formulation and extrusion product were analyzed with a TA Instrument DSC with a heating rate of 15° C./min. The results of this analysis showed that the extruded dispersion was completely amorphous as evidenced by the disappearance of the melting peaks of the crystalline ingredients in the powder formulation, including the peak corresponding to WS-5 (FIG. 5).

### Example 6: Encapsulated WS-5 Exhibits Improved Release

Mint Tablet Preparation.

Fifty parts granulated sugar and 50 parts sorbitol were blended with 0.6 parts magnesium stearate, 0.10 parts of menthol crystal, and 0.6 parts of the encapsulated WS-5 composition described in Example 5. Pressed mint with unit weight of 1.0 gram was formed on a Carver press under 2000 psi. A control mint tablet was formed similarly but used 0.06 parts pure WS-5. Both tablets contained nominal 600 ppm WS-5.

Sensory Evaluation.

A panel of 12 trained sensory evaluators tasted the cooling properties of tablet samples for 5 minutes. Cooling intensity was recorded continuously with an electronic device. The test was blinded, randomized, and balanced. The results of this analysis indicate that the encapsulated WS-5 significantly outperformed unencapsulated (or neat) WS-5 (FIG. 6).

### Example 7: Loading Level of Cooling Agent

Formulation/Encapsulation.

Formulations were prepared as described in Example 5, using two different levels of WS-5, 10% and 15%. For the 15% WS-5 formulation, the other ingredients were proportionally lowered to retain a constant total formulation amount.

DSC Analysis.

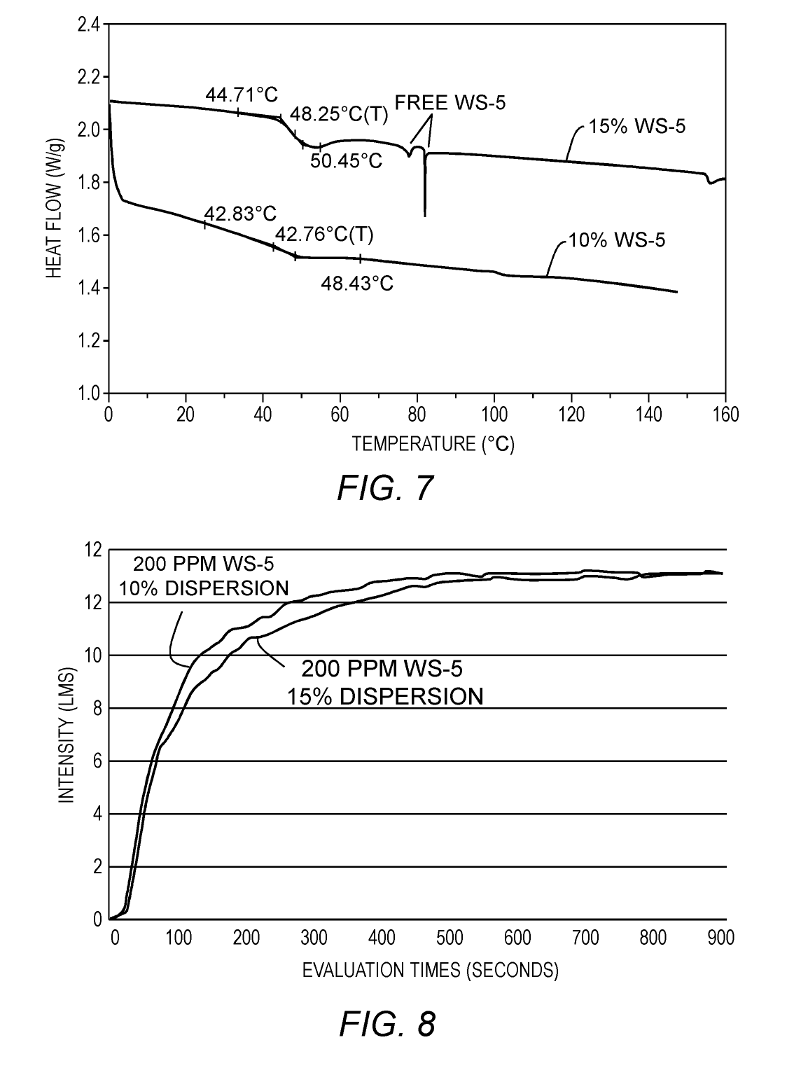

To assess the structure of the formulations, DSC analysis was conducted. This analysis indicated that a fraction of WS-5 remained crystalline in the 15% WS-5 dispersion (FIG. 7) suggesting that the 15% load was too high for WS-5 with this matrix.

Chewing Gum Preparation.

Two chewing gums were made in a Sigma Blade lab mixer with the 10% and 15% WS-5 encapsulated compositions. The formulations contained a Cafosa Hades gum base, sorbitol as bulk sweetener, and aspartame and acesulfame K as high intensity sweeteners. The flavor portion was composed of 1.4% mint oil and 200 ppm WS-5.

Sensory Comparison.

A panel of 12 trained sensory evaluators chewed the above gums for 12 minutes. Cooling intensity was recorded continuously with an electronic device. The test was blinded, randomized, and balanced. The results of this analysis showed that the gum incorporating the 10% WS-5 (fully amorphous) dispersion outperformed the gum containing the 15% WS-5 (partially crystalline)(FIG. 8).

### Example 8: Modification of Matrix Materials

Formulation.

To test different matrix materials, a sugar-free matrix was compared to a high-melt matrix. The sugar-free matrix was prepared as described in Example 5. The high-melt matrix was prepared by combining 1.302 kg dextrin, 1.333 kg isomalt, 0.476 kg modified starch, 0.222 kg KLUCEL GF, 0.400 kg WS-5, 0.044 monoglyceride, and 0.133 kg fumed silica in a Hobart mixer at low speed for five minutes. Subsequently, 0.089 kg sunflower lecithin was slowly added and the mixture was blended for 10 minutes.

Extrusion/Encapsulation.

The powder mixes were fed into a Coperion ZSK-25 twin-screw extruder at a controlled rate, wherein the highest zone temperature was set at 170° C. The material was extruded through a die block with a hole of 1 mm in diameter, and air-cooled on a belt.

DSC Analysis.

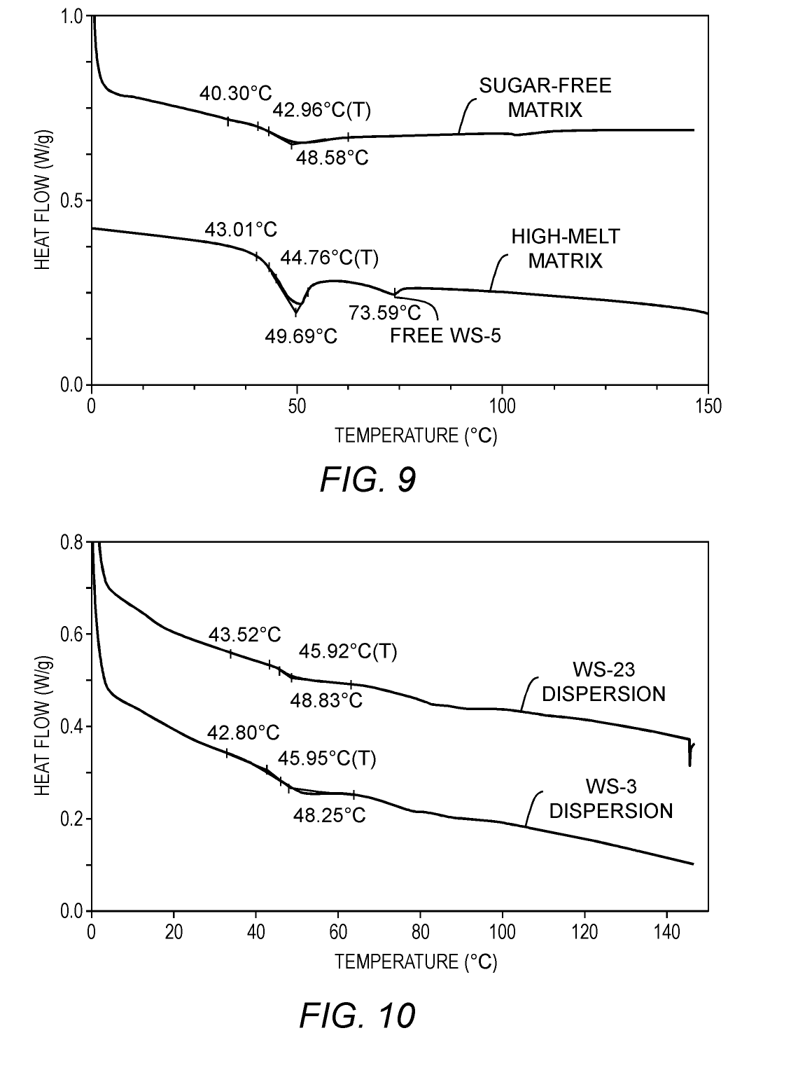

DSC analysis was conducted to compare the structure of the sugar-free and high-melt matrices. This analysis indicated that while the sugar-free matrix was completely amorphous, the high-melt matrix retained a small WS-5 melting peak at approximately 74° C. (FIG. 9). Accordingly, in certain embodiments of this invention, a sugar-free matrix is used to achieve an amorphous composition.

### Example 9: Encapsulation of WS-3 and WS-23

Formulation/Encapsulation.

Formulations containing WS-3 and WS-23 were prepared as described in Example 5, with WS-3 or WS-23 replacing WS-5.

DSC Analysis.

To analyze the structure of the WS-3 and WS-23 encapsulated compositions, DSC analysis was conducted. The results of this analysis indicated that both dispersions were completely amorphous, i.e., no crystalline melt peak existed for either WS-3 or WS-23, only a glass transition at approximately 46° C. (FIG. 10).

### Example 10: Encapsulation of Other Coolants

Formulation/Encapsulation.

Formulations containing CoolTek 27 and NoSSM were prepared as described in Example 5, with CoolTek 27 or NoSSM replacing WS-5.

DSC Analysis.

DSC analysis of the CoolTek 27 and NoSSM encapsulated products indicated that both cooler/tastants remained in crystalline form in the encapsulated samples. Retention of the crystalline form was likely due to either the higher melting points of CoolTek 27 and NoSSM (>200° C., compared to the 170° C. extrusion temperature), or poor compatibility with the sugar-free matrix.

Chewing Gum Preparation.

Two chewing gums were made in a Sigma Blade lab mixer, one with encapsulated CoolTek 27 and the other with neat CoolTek 27. The formulations contained a Cafosa Hades gum base, sorbitol as bulk sweetener, and aspartame and acesulfame K as high intensity sweeteners. The flavor portion was composed of 1.4% mint oil and 200 ppm CoolTek 27.

Sensory Comparison.

A panel of 12 trained sensory evaluators chewed the above gums for 12 minutes. Cooling intensity was recorded continuously with an electronic device. The test was blinded, randomized, and balanced. The results of this analysis showed that there was no difference in intensity between the gum containing encapsulated CoolTek 27 and the gum containing the unencapsulated CoolTek 27. This analysis indicates that an “amorphous” dispersion provides an improvement in the release characteristics of water-insoluble cooling agents.

1. A composition comprising one or more water-insoluble cooling agents, each having a water solubility of 2 mg/g or less, and being encapsulated in a water-soluble matrix comprising
(a) at least one water-soluble carbohydrate; and
(b) at least one emulsifier.

2. The composition of claim 1, wherein the water solubility of each of the one or more water-insoluble cooling agents is 1 mg/g or less.

3. The composition of claim 1, wherein the water solubility of each of the one or more water-insoluble cooling agents is 0.5 mg/g or less.

4. The composition of claim 1, further comprising a cooling enhancer.

5. The composition of claim 1, further comprising a liquid-absorbing powder material.

6. The composition of claim 1, wherein the at least one water-soluble carbohydrate comprises a modified starch, a dextrin, a sugar, a sugar alcohol, or a combination thereof.

7. The composition of claim 1, wherein the one or more water-insoluble cooling agents are in the form of a solid crystalline powder or viscous liquid at 20° C.

8. A composition comprising by weight of the composition:
(i) 5%-35% of one or more water-insoluble cooling agents, and
(ii) a water-soluble matrix encapsulating the one or more water-insoluble cooling agents, in which the water-soluble matrix contains by weight of the composition:
(a) 10%-50% of one or more sugars or sugar alcohols;
(b) 10%-60% of at least one water-soluble carbohydrate polymer;
(c) 0.1%-10% of one or more emulsifiers; and
(d) 0-10% of one or more liquid-absorbing materials.

9. The composition of claim 8, further comprising a cooling enhancer.

10. The composition of claim 8, wherein the at least one water-soluble carbohydrate polymer comprises a modified starch and dextrin.

11. The composition of claim 8, wherein the one or more sugar alcohols comprise mannitol, sorbitol, lactitol, isomalt, erythritol, xylitol, maltitol, or hydrogenated isomaltulose.

12. The composition of claim 8, wherein the one or more water-insoluble cooling agents are solid crystalline powders or viscous liquids at 20° C.

13. The composition of claim 1, wherein said composition is amorphous.

14. A consumer product comprising the composition of claim 1.

15. A method for preparing a composition of claim 1, the method comprising the steps of:
a) blending
(i) one or more water-insoluble cooling agents, each in the form of a solid or viscous liquid and having a water solubility of 2 mg/g or less,
(ii) at least one water-soluble carbohydrate, and
(iii) at least one emulsifier to produce a powder mixture;
b) melting the powder mixture in an extruder;
c) extruding the melted powder mixture through a die; and
d) cooling the extruded powder mixture to produce the composition of claim 1.

16. The method of claim 15, further comprising
e) grinding the composition of claim 1 to a granule or powdered form.

17. A method for preparing a composition of claim 8, the method comprising the steps of:
a) blending, by weight, 5%-35% of one or more water-insoluble cooling agents with a water-soluble matrix comprising:
(i) 10%-50% of one or more sugars or sugar alcohols;
(ii) 10%-60% of at least one water-soluble carbohydrate polymer;
(iii) 0.1%-10% of one or more emulsifiers; and
(iv) 0-10% of one or more liquid-absorbing materials to produce a powder mixture;
b) melting the powder mixture in an extruder;
c) extruding the melted powder mixture through a die; and
d) cooling the extruded powder mixture to produce the composition of claim 8.

18. The method of claim 17, further comprising
e) grinding the composition of claim 8 to a granule or powdered form.

19. The composition of claim 8, wherein said composition is amorphous.

20. A consumer product comprising the composition of claim 8.
